(19) United States
(12) Patent Application Publication
(10) Pub. No.: US 2026/0159777 A1
(43) Pub. Date: Jun. 11, 2026

(54) CANDLE COMPOSITION AND METHOD FOR THE PRODUCTION OF A CANDLE

(71) Applicant: NYITA COLLECTION LTD, London (GB)

(72) Inventor: Rebecca JAQUEST, London (GB)

(73) Assignee: NYITA COLLECTION LTD, London (GB)

(21) Appl. No.: 19/124,749

(22) PCT Filed: Oct. 13, 2023
(86) PCT No.: PCT/GB2023/052668

§ 371 Date: Apr. 25, 2025

(30) Foreign Application Priority Data
Oct. 28, 2022 (GB) 2215991.7

(51) Int. Cl. C11C 5/00

(52) U.S. Cl. CPC C11C 5/002

(57) ABSTRACT

The invention is directed at a candle composition that is made using natural ingredients, the candle composition comprising at least one vegetable-derived wax, such as sunflower wax, in an amount of about 10% by weight to about 40% by weight; at least one vegetable oil in an amount of about 60% by weight to about 90% by weight, and about 0% to about 15% by weight of a scent. The invention is further directed at methods for the manufacture of a candle.

### FIELD

The present invention relates to compositions for the preparation of candles, and in particular, for the preparation of sunflower wax candles.

### BACKGROUND OF THE INVENTION

Many compounds and formulations have been used over the years for the manufacture of candles. Paraffin wax has generally replaced beeswax and tallow (animal fats) as the dominant combustible material in candles. Paraffin wax is made from petroleum (crude oil), which, as a non-renewable resource, is not sustainable. Further, paraffin waxes are not considered to be biodegradable as they release a range of toxic chemicals in the surrounding environment as they decompose, which may take several decades. In addition, burning paraffin wax releases potentially dangerous chemicals such as toluene.

An alternative to paraffin wax for candles is vegetable wax. US 2016/0251597 A1 discloses a candle composition comprising 60% to 80% by weight rice bran wax and 20% to 40% by weight coconut oil. Candles made with other vegetable oils such as soy oil and palm oil, though renewable, must be hydrogenated in order to raise the melting temperature to be acceptable for candle making and a petrochemical, often hexane, is used as a solvent in the hydrogenation process. Furthermore, soy oil is sourced from GMO plants and palm oil plantations impact wildlife and global warming.

It is an object of the present invention to provide a candle made using natural ingredients that is sustainably sourced, non-hydrogenated, biodegradable, GMO-free and animal free, that does not suffer from the disadvantages of existing plant-based candles mentioned above.

### SUMMARY OF THE INVENTION

The present invention accordingly provides a candle composition comprising at least one vegetable-derived wax in an amount of about 10% by weight to about 40% by weight; at least one vegetable oil in an amount of about 60% by weight to about 90% by weight, and a scent in an amount of about 0% to about 15% by weight of a scent.

In a preferred embodiment, the candle composition comprises about 15% to about 35% by weight vegetable-derived wax, about 65% to about 85% by weight vegetable oil, and about 7% to about 12.5% by weight scent. The scent is preferably 100% natural and derived from plants, fruits and/or seeds.

In one embodiment, the candle composition comprises about 20% by weight vegetable derived wax; about 70% by weight vegetable oil; and about 10% by weight scent.

In another embodiment, the candle composition comprises about 20% by weight vegetable derived wax; and about 80% by weight vegetable oil.

In one embodiment, the vegetable oil component of the candle composition consists of 100% non-hydrogenated vegetable oil.

Vegetable-derived wax included in the composition of the present invention is solid at room temperature and melts at above about 40° C., preferably within the range from about 65° C. to about 85° C. In one embodiment, the vegetable-derived wax included in the composition of the present invention has a melting point of from about 75° C. to about 78° C. The vegetable oil component of the candle composition may have a melting point of about −20° C. to about 40° C.

In one embodiment, the vegetable-derived wax is selected from one or more of: sunflower wax, rice wax, olive wax, carnauba wax, mimosa wax, candelilla wax, jojoba wax, myrica wax, berry wax and castor wax. In a preferred embodiment, the vegetable-derived wax is sunflower wax or a blend of sunflower wax and one or more different vegetable-derived waxes.

A further aspect of the present invention is a candle comprising a wick and a candle composition as described.

A yet further aspect of the present invention is a method for the manufacture of a candle composition, comprising: providing a homogeneous melt of at least one vegetable-derived wax in an amount of about 10% by weight to about 40% by weight; at least one vegetable oil in an amount of about 60% by weight to about 90% by weight; and a scent in an amount of about 0% to about 15% by weight.

In one embodiment, the homogeneous mixture is formed by heating the vegetable-derived wax to melt it, and blending the vegetable oil and melted wax. Scent is preferably added after the homogeneous mixture has been cooled slightly, for example by about 1° C. to about 10° C., about 20° C. or about 30° C.

A yet further aspect of the present invention is a method for the manufacture of a candle, comprising: providing a homogeneous liquid mixture of a composition comprising at least one vegetable-derived wax in an amount of about 10% by weight to about 40% by weight; at least one vegetable oil in an amount of about 60% by weight to about 90% by weight, and a scent in an amount of about 0% to about 15% by weight; and pouring the liquid mixture or melt into a mould or container.

In one embodiment, pouring the liquid mixture or melt into a mould or container comprises pouring the liquid mixture or melt into the mould or container to partially fill the mould or container and to form a first layer; pouring at least two further layers into the mould or container; wherein each layer is at least partially cured before the next layer is applied; and wherein each layer after the first has a thickness that is less than the thickness of the first layer.

In one embodiment of the method, pouring the liquid mixture or melt into a container or mould comprises the steps of:
(1) pouring a first layer;
(2) after the first layer has at least partially cured, pouring a second layer on to the first layer, wherein the thickness of the second layer is less than the thickness of the first layer;
(3) after the second layer has at least partially cured, pouring a third layer on to the second layer, wherein the thickness of the third layer is less than the thickness of the first layer; optionally repeating step (3) with one more further layers.

In one preferred embodiment of the method, the second, third, and any subsequent layers are each about 10 to about 25% of the thickness of the first layer.

In one preferred embodiment of the method, the second, third and any subsequent layers are about equal in thickness.

In one preferred embodiment of the method, the first layer is approximately 50% of the thickness of the finished candle.

In one preferred embodiment of the method, the container or mould is pre-heated, preferably to above the melt point of the wax, more preferably to about 140° C. to about 150° C.

In one preferred embodiment of the method, a layer is cured by allowing it to cool at room temperature. In an alternative embodiment, a layer is cured by cooling it at below room temperature. In one embodiment, a period of about 12 hours, 1 to 3 days, one week or up to two weeks is allowed for curing a layer.

In one preferred embodiment of the method, a wick is provided in the pre-heated container or mould before the mixture is poured into it.

The number of layers after the first layer generally depends on the relative amount of wax to oil present in the composition. The number of layers after the first layer is preferably greater than two or three when the wax is present in the composition in an amount of about 25 to about 40% by weight. The number of layers after the first layer is preferably two, three or less when the wax is present in the composition in an amount of about 10 to about 20% by weight.

The method according to the present invention provides a candle that has a smooth surface and is free from cracks and surface defects. Further, the candle produced does not contain synthetic chemicals, is made from renewable resources, is 100% biodegradable, and does not contain waxes of mineral (e.g., petroleum) or animal (e.g., bee) origin or waxes derived from origins that are not environmentally friendly such as palm oil.

The method according to the present invention can be used to produce candles of various types, including container candles and standalone candles, which are required to be solid with a smooth, glassy appearance.

### DEFINITIONS

The following definitions shall apply throughout the specification and the appended claims.

Within the context of the present application, the terms “comprises” and “comprising” are interpreted to mean “includes, among other things”. These terms are not intended to be construed as “consists of only”.

The terms “about” and “approximately” mean plus or minus 20%, more preferably plus or minus 10%, even more preferably plus or minus 5%, most preferably plus or minus 2%. For example, “about 10% by weight” means 8 to 12% by weight, more preferably 9 to 11% by weight, even more preferably 9.5 to 10.5% by weight, most preferably 9.8 to 10.2% by weight; and “about 40% by weight” means 32 to 48% by weight, more preferably 36 to 44% by weight, even more preferably 38 to 42% by weight, most preferably 39.2 to 40.8% by weight.

By “thickness” is meant depth or the vertical distance through a candle that is in the upright position.

### DETAILED DESCRIPTION OF THE INVENTION

### Vegetable Derived Wax

An example of a suitable vegetable-derived wax for use in the present invention is sunflower wax.

A sunflower wax is a long-chain saturated ester (in the range of 36-60 carbon atoms, C36-C60) derived from fatty alcohols and fatty acids. It is obtained from sunflower oil by chilling (winterization) to temperatures of approximately 10-15° C. to facilitate crystallization, followed by removal of the crystalized wax by, for example, filtration or centrifugation. It is an organic process with no additional ingredients added to the wax. Sunflower oil and wax is sourced from GMO-free crops. Sunflower wax is sustainable, the production of sunflower wax adds value to the supply chain as it makes use of crude materials that would otherwise be thrown away.

A suitable sunflower wax has at least one of the following characteristics:
Melting Point: 74-77° C; Acid Value: <5 (mg KOH/g); Saponification Value: 78-92 (mg KOH/g). In certain embodiments the sunflower wax is sourced from Koster Keunen.

### Vegetable Oil

A suitable vegetable oil for use in the present invention is liquid at a temperature of from 0° C. to 30° C., and can contain triglycerides of saturated and unsaturated fatty acids. Examples of vegetable oils include, but are not limited to: coconut oil, sunflower oil, olive oil, corn oil, canola oil, safflower oil, rapeseed oil and cottonseed oil, which can be present individually or as a blend of two or more different oils.

### Candle

The candle of the present invention preferably includes at least one wick which typically extends longitudinally from one end of the candle to the other. The wick may be made from woven cotton or any other suitable material known in the art. The candle, in one embodiment, is provided in a candle container which is preferably composed of glass or any heat resistant material.

### EXAMPLES

The following examples are provided for illustrative purposes only and for a better understanding of the present invention. They are not intended to limit the scope of the present invention.

### Manufacturing Method

The components of the candle were weighed and combined in a melter. The composite material was obtained by heating to melt all solid components to a liquid state with sufficient stirring to uniformly mix all components. The temperature range for the melting was normally between about 75° C. to about 110° C., in particular between about 80° C. to about 90° C.

After the components were mixed, the composite material was either directly poured into product containers or moulds (that may be pre-heated to about 140-150° C.) or was allowed to cool to slightly below, e.g., about 1 to about 20° C. below, the melting temperature before being poured into the product containers or moulds. If scent is used it was stirred in gently after the material had cooled slightly. Preferably, scent is added to the composite material after the temperature of the melted components has cooled to between about 55° C. to about 74° C. or by about 1° C. to about 30° C. A wick was normally added to the pre-heated container either before the material was added or after the material was added and while it was still in the liquid state. The product was then cooled by standing at ambient temperature (room temperature), or by the use of a cooling process, such as temperature controlled water bath, if more rapid cooling was desired. The candle was cured for about 10 hours or overnight. The candle could be removed from the mould after the mould was cool to the touch.

### Method Using a Single Pour Step

The composite melted material was manufactured as described above and poured into the product container or mould to fill it to the height desired for the depth of the finished candle. The product was cooled until cured as indicated.

### Method Using a Multi-Pour Step

The composite melted material was manufactured as described above and poured into the product container or mould so as to fill it to about 50% of its depth, or to about 50% of the expected height of the finished candle to provide a first layer. After the first layer had cured, a second layer of melted material was poured on to the first layer. The second layer covered the entire top surface of the first layer and had a depth of approximately 10 mm, or less than about 25% of the depth of the first layer. After the second layer had cured, a third layer of melted material was poured on to the second layer. The third layer covered the entire top surface of the second layer and had a depth of about 10 mm, or less than about 25% of the depth of the first layer. Further layers were added in the same manner, as required.

In one method, the composite material for the second, third and subsequent layers were heated to slightly higher than the original melting temperature prior to pouring. This has the effect of preventing the formation of a visual line between the layers.

### Example 1

A 100% vegetable-based candle was prepared in accordance with the described method. The vegetable oil amount was about 75% by weight of the candle and the vegetable wax amount was about 25% by weight of the candle. The vegetable wax is preferably sunflower wax. The vegetable oil is preferably sunflower oil or coconut oil. In other examples, the composition may include other components, such as natural colorants or scent.

### Example 2

A candle containing vegetable wax, vegetable oil and scent was prepared in accordance with the described method. The vegetable oil amount was about 70% by weight of the candle, the vegetable wax amount was about 20% by weight of the candle and the scent was about 10% of the weight of the candle. The vegetable wax is preferably sunflower wax. The vegetable oil is preferably sunflower oil or coconut oil. The scent is a natural scent, preferably an essential oil such as the oils derived from lavender, rose or citronella. In other examples, the composition may include other components, such as colourants.

### Comparative Example

A 100% vegetable-based candle was prepared in accordance with the method described above. The vegetable wax amount was 60 to 80% by weight of the composition and the vegetable oil amount was 40 to 20% by weight of the composition.

### Results

The candles of Examples 1 and 2 that were prepared using the method with a single-pour step had a smooth and glossy external appearance, but some cracks appeared after the product had cooled.

The candles of Examples 1 and 2 that were prepared using the method with a multi-pour step had a smooth and glossy external appearance with no cracks, even after the product had cooled.

The candles of the comparative Example prepared using the method with a single-pour step showed some cracks and did not have a smooth surface and did not adhere to the surface of the container.

The candles of the comparative Example prepared using the method with the multi-pour step showed, in addition to some cracks and a surface that was not smooth and that did not adhere to the surface of the container, individual layers to be in the form ridges.

It should be understood that various changes and modifications to the presently preferred embodiments described herein will be apparent to those skilled in the art. Such changes and modifications can be made without departing from the scope of the present invention and without diminishing its attendant advantages. It is therefore intended that such changes and modifications are covered by the appended claims.

1. A candle comprising sunflower wax in an amount of about 10% by weight to about 25% by weight; coconut oil in an amount of about 75% by weight to about 90% by weight, and about 0% to about 15% by weight of a scent.

2. A candle according to claim 1, comprising about 15% by weight sunflower wax, about 85% by weight coconut oil, and about 7% to about 12.5% by weight scent.

3. A candle according to claim 1, comprising about 20% by weight sunflower wax; and about 10% by weight scent.

4. A candle according to, comprising about 20% by weight sunflower wax; and about 80% by weight coconut oil.

5. A method for the manufacture of a candle according to claim 1, comprising heating the sunflower wax from about 80° C. to about 90° C., blending the coconut oil and melted wax to form a homogeneous mixture, and, optionally, adding scent to the mixture after cooling the mixture to a temperature of about 55° C. to about 74° C..

6. A method for the manufacture of a candle, comprising providing a homogeneous liquid mixture of a composition comprising sunflower wax in an amount of about 10% by weight to about 25% by weight; coconut oil in an amount of about 75% by weight to about 90% by weight, and a scent in an amount of about 0% to about 15% by weight; pouring the melt into a mould or container to partially fill the mould or container and to form a first layer; pouring at least two further layers into the mould or container; wherein each layer is at least partially cured before the next layer is applied; and wherein each layer after the first has a thickness that is less than the thickness of the first layer.

7. A method for the manufacture of a candle, comprising:
providing a homogeneous melt of a candle composition comprising sunflower wax in an amount of about 10% by weight to about 25% by weight; coconut oil in an amount of about 75% by weight to about 90% by weight, and about 0% to about 15% by weight of a scent; pouring the melt into a container or mould, wherein the pouring comprises the steps of:
(1) pouring a first layer;
(2) allowing the first layer to at least partially cure;
(3) pouring a second layer on to the first layer; and
(4) allowing the second layer to at least partially cure;
repeating steps (3) and (4) with a third layer on to the second layer; and, optionally, with a fourth layer on to the third layer; and, optionally, with a fifth layer on to the fourth layer; and, optionally, with a sixth layer on to the fifth layer; and, optionally, with one or more further layers; wherein the thickness of each of the second layer and subsequent layers is less than the thickness of the first layer.

8. A method according to claim 6, wherein the second and subsequent layers are each about 10 to about 25% of the thickness of the first layer.

9. A method according to claim 7, wherein the second and subsequent layers are each about equal in thickness.

10. A method according to claim 7, wherein the first layer is approximately 50% of the thickness of the finished candle.

11. A method according to claim 7, wherein the container or mould is pre-heated, preferably from about 140° C. to about 150° C.

12. A method according to claim 7, wherein a wick is provided in the container or mould before the mixture is poured into it.

13. (canceled)

14. (canceled)
